(19) United States
(12) Patent Application Publication
(10) Pub. No.: US 2017/0137086 A1
(43) Pub. Date: May 18, 2017

(54) BICYCLE DRIVE UNIT

(71) Applicant: Shimano Inc., Osaka (JP)

(72) Inventor: Takashi YAMAMOTO, Osaka (JP)

(21) Appl. No.: 15/334,414

(22) Filed: Oct. 26, 2016

(30) Foreign Application Priority Data
Nov. 17, 2015 (JP) 2015-225008

(51) Int. Cl. B62M 6/55; F16H 37/06; F16H 3/66; B62M 11/18; B62M 6/45

(52) U.S. Cl. CPC B62M 6/55; B62M 11/18; B62M 6/45; F16H 3/66; F16H 37/065; F16H 2200/2007; F16H 2200/2069; F16H 2200/2084

(57) ABSTRACT

A bicycle drive unit includes a first planetary gear mechanism, a first motor, a second motor and a resultant force member. The first planetary gear mechanism includes a first input body, a first output body and a first transmission body that transmits the rotation of the first input body to the first output body. The first motor is configured to rotate the first input body. The second motor is configured to rotate the first transmission body. The resultant force member is selectively rotated by the rotation of the first output body and by a manual drive force without interposing the first planetary gear mechanism.

### CROSS-REFERENCE TO RELATED APPLICATIONS

This application claims priority to Japanese Patent Application No. 2015-225008, filed on Nov. 17, 2015. The entire disclosure of Japanese Patent Application No. 2015-225008 is hereby incorporated herein by reference.

### BACKGROUND

Field of the Invention

The present invention relates to a bicycle drive unit.

Background Information

Some bicycles are provided with a bicycle drive unit to assist the rider by generating an auxiliary drive force. A bicycle drive unit comprises a motor for assisting a manual drive force. In addition to the motor, the bicycle drive unit often further comprises a reduction gear that decelerates and outputs the rotation of the motor, a resultant force member to which rotation is transmitted from each of the reduction gear and a crankshaft, and the like. One example of such a conventional bicycle drive unit is disclosed in Japanese Patent No. 2,623,419.

### SUMMARY

Generally, the present disclosure is directed to various features of a bicycle drive unit. In a conventional bicycle drive unit, the rotational speed of the motor is proportional to the rotational speed of the crank. Since the motor has a characteristic in which the output torque varies according to the rotational speed, there is the risk that the output torque of the motor will be insufficient, thereby either reducing the assisting force, or reducing the driving efficiency of the motor, depending on the rotational speed of the crank.

One object of the present invention is to provide a bicycle drive unit that can prevent a reduction in the assisting force accompanying a change in the rotational speed of the crank.

In view of the state of the known technology and in accordance with a first aspect of the present disclosure, a bicycle drive unit according to the present invention comprises a first planetary gear mechanism, a first motor, a second motor and a resultant force member. The first planetary gear mechanism includes a first input body, a first output body and a first transmission body that transmits the rotation of the first input body to the first output body. The first motor is configured to rotate the first input body. The second motor is configured to rotate the first transmission body. The resultant force member configured to selectively receive rotation of the first output body and rotation by a manual drive force without interposing the first planetary gear mechanism.

According to one example of the bicycle drive unit, the resultant force member is provided around a rotational axis of a crankshaft and is rotatable around the rotational axis of the crankshaft.

One example of the bicycle drive unit further comprises a transmitting member configured to transmit rotation of the first motor to the first input body.

According to one example of the bicycle drive unit, the transmitting member comprises an output shaft of the first motor.

One example of the bicycle drive unit further comprises a first one-way clutch. The first one-way clutch is configured to transmit rotation of the transmitting member to the first input body while the transmitting member is rotated in a first direction and while a rotational speed of the first input body and a rotational speed of the transmitting member are equal. The first one-way clutch is coupled to the transmitting member and the first input body so as to not transmit the rotation of the transmitting member to the first input body while the rotational speed of the first input body is higher than the rotational speed of the transmitting member.

One example of the bicycle drive unit further comprises a first speed reducer configured to reduce a rotational speed of the first output body and transmit the rotational speed of the first output body to the resultant force member.

According to one example of the bicycle drive unit, the first speed reducer comprises a second planetary gear mechanism, a second output body and a second transmission body. The second planetary gear mechanism has a second input body that receives a rotational input from the first output body. The second body transmits rotation to the resultant force member. The second transmission body that transmits the rotation of the second input body to the second output body.

According to one example of the bicycle drive unit, the first transmission body and the second transmission body are integrated so as to be synchronously rotatable.

According to one example of the bicycle drive unit, the first transmission body and the second transmission body are individually configured so as to be relatively rotatable.

According to one example of the bicycle drive unit, the second input body comprises a sun gear that is coupled to the first output body. The second output body comprises a planetary gear and a carrier. The planetary gear is engaged with the second input body. The carrier rotatably supports the planetary gear. The second transmission body comprises a ring gear that is engaged with the second output body.

According to one example of the bicycle drive unit, the first input body comprises a sun gear that is coupled to the first motor. The first output body comprises a planetary gear and a carrier. The planetary gear is engaged with the first input body. The carrier rotatably supports the planetary gear. The first transmission body comprises a ring gear that is engaged with the first output body.

One example of the bicycle drive unit further comprises a second speed reducer configured to reduce a rotational speed of the second motor and transmit the rotational speed of the second motor to the first transmission body.

One example of the bicycle drive unit further comprises a housing supporting the first planetary gear mechanism, the first motor, and the second motor.

According to one example of the bicycle drive unit, the second transmission body is non-rotatable with respect to the housing.

One embodiment of the bicycle drive unit further comprises a second one-way clutch configured to prevent rotation of the first transmission body in a predetermined direction.

One example of the bicycle drive unit further comprises a controller configured to control the first motor and the second motor.

According to one example of the bicycle drive unit, the controller is configured to control the first motor and the second motor according to a manual drive force and a rotational speed of a crank.

According to one example of the bicycle drive unit, when the rotational speed of the crank becomes higher than a prescribed speed, the controller is configured to control a rotational speed of the second motor so as to be higher than the rotational speed of the second motor than when the rotational speed of the crank is at the prescribed speed or lower.

According to one example of the bicycle drive unit, the controller is configured to continuously change the rotational speed of the second motor in accordance with the rotational speed of the crank.

One example of the bicycle drive unit further comprises a crankshaft.

The bicycle drive unit of the present invention is configured to suppress a reduction in the assisting force accompanying a change in the rotational speed of the crank.

### BRIEF DESCRIPTION OF THE DRAWINGS

Referring now to the attached drawings which form a part of this original disclosure.

FIG. 1 is a side elevational view of a drivetrain of an electrically assisted bicycle equipped with a bicycle drive unit in accordance with a first embodiment.

FIG. 2 is a cross-sectional view of the bicycle drive unit as seen along section line 2-2 in FIG. 1.

FIG. 3 is a cross-sectional view of the bicycle drive unit in accordance with a second embodiment.

FIG. 4 is a schematic diagram of the bicycle drive unit in accordance with a first modification.

FIG. 5 is a schematic diagram of the bicycle drive unit in accordance with a second modification.

FIG. 6 is a schematic diagram of the bicycle drive unit in accordance with a third modification.

FIG. 7 is a schematic diagram of the bicycle drive unit in accordance with a fourth modification.

FIG. 8 is a schematic diagram of the bicycle drive unit in accordance with a fifth modification.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

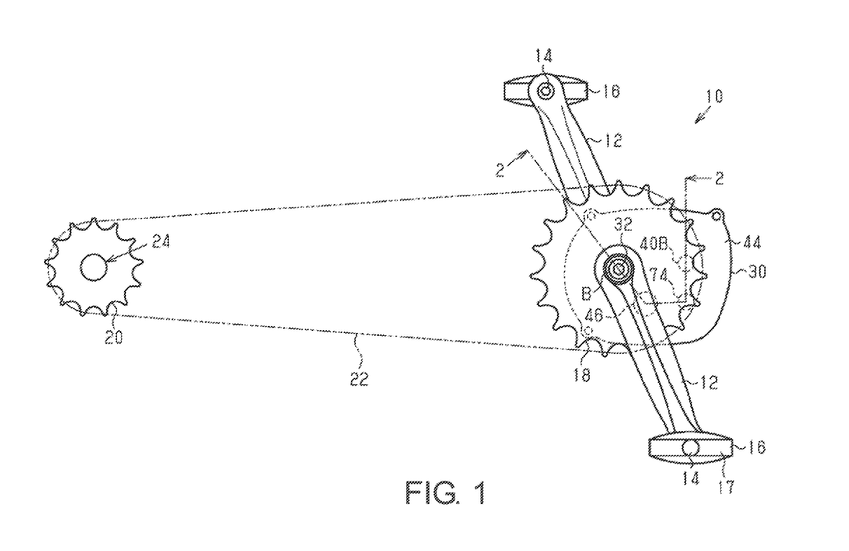

An electrically assisted bicycle 10 shown in FIG. 1 comprises a bicycle drive unit (hereinafter referred to as “drive unit 30”) in accordance with a first embodiment. In one example, the electrically assisted bicycle 10 further comprises a pair of crank arms 12, a pair of pedals 16, a front sprocket 18, a rear sprocket 20, a chain 22 and a first clutch 24.

The crank arms 12 are coupled to the opposite ends of a crankshaft 32 in a state of being integrally rotatable with the crankshaft 32 of the drive unit 30. The crank arms 12 together with the crankshaft 32 form a crank. The pedals 16 each comprise a pedal main body 17 and a pedal shaft 14. The pedal shafts 14 are coupled to the crank arms 12, respectively. The pedal main bodies 17 are supported on the pedal shafts 14, respectively, in a state of being rotatable with respect to the pedal shafts 14.

The front sprocket 18 is coupled with the drive unit 30 via a resultant force member 42 of the drive unit 30. The rear sprocket 20 is coupled with a rear wheel (not shown) of the electrically assisted bicycle 10 via the first clutch 24. The first clutch 24 is a one-way clutch that transmits the rotation of the front sprocket 18 to the rear wheel, and which does not transmit the rotation of the rear wheel to the front sprocket 18. The chain 22 is engaged with the front sprocket 18 and the rear sprocket 20.

The function of the drive unit 30 is to assist the manual drive force that is inputted to the crankshaft 32. The drive unit 30 is mounted to a frame of the electrically assisted bicycle 10 and is detachable with respect to the frame. An example of a means to join the drive unit 30 and the frame are bolts. A battery (not shown) is mounted on the frame of the electrically assisted bicycle 10. The battery (not shown) is configured to supply electrical energy to the drive unit 30.

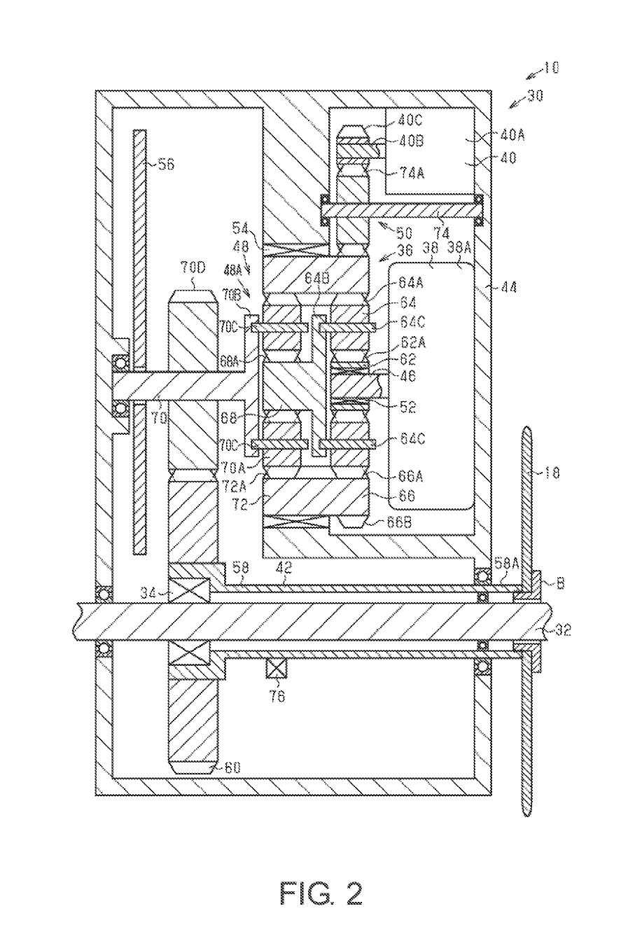

As shown in FIG. 2, the drive unit 30 comprises a first planetary gear mechanism 36, a first motor 38, a second motor 40 and a resultant force member 42. One example of the first motor 38 is an electric motor. One example of the second motor 40 is an electric motor. In one example, the drive unit 30 further comprises the crankshaft 32, a housing 44, a transmitting member 46, a first speed reducer 48, a second speed reducer 50, a first one-way clutch 52, a second one-way clutch 54 and a controller 56. The controller 56 is programmed to execute a control program that is set in advance. The controller 56 comprises a processor, for example, a CPU (Central Processing Unit) or an MPU (Micro Processing Unit). The controller 56 preferably includes a memory device for storing programs and data.

The crankshaft 32 is supported by the drive unit 30 in a state of being rotatable with respect to the drive unit 30. Both ends of the crankshaft 32 protrude from the housing 44. The first planetary gear mechanism 36, the first motor 38, the second motor 40, the transmitting member 46, the first one-way clutch 52, the second one-way clutch 54, the first speed reducer 48 and the controller 56 are provided in the housing 44.

The rotation of the first output body 64 described later is transmitted to the resultant force member 42, and the rotation by the manual drive force is applied without interposing the first planetary gear mechanism 36. The resultant force member 42 comprises a hollow shaft 58 and a gear 60. The hollow shaft 58 is supported in the housing 44 in a state of being rotatable with respect to the housing 44. The resultant force member 42 is provided around the rotational axis of the crankshaft 32. The resultant force member 42 is configured to rotate around the rotational axis of the crankshaft 32. One end 58A of the hollow shaft 58 protrudes from the housing 44. The crankshaft 32 is inserted in the hollow shaft 58 so that both ends protrude from the hollow shaft 58 and the housing 44. The crankshaft 32 is supported in the housing 44 via the hollow shaft 58. The gear 60 is attached to the hollow shaft 58 in a state of being non-rotatable with respect to the hollow shaft 58. The gear 60 is provided coaxially with the hollow shaft 58. In another example, the gear 60 can be integrally formed with the hollow shaft 58 during the formation of the hollow shaft 58.

The second clutch 34 is provided between the outer perimeter of the crankshaft 32 and the inner perimeter of the resultant force member 42. The second clutch is a one-way clutch. The second clutch 34 transmits rotation from the crankshaft 32 to the resultant force member 42 while the crankshaft 32 is rotated forward. The second clutch 34 is coupled with the crankshaft 32 and the resultant force member 42 so as to not transmit rotation from the crankshaft 32 to the resultant force member 42 while the crankshaft 32 is rotated rearward.

The front sprocket 18 is arranged on the side of the housing 44 and located outside of the housing 44. The front sprocket 18 is attached to the drive unit 30 by a bolt B. The bolt B is threaded into the resultant force member 42 so that the front sprocket 18 is fixed between the resultant force member 42 and the bolt B.

When a manual drive force is inputted to the pedals 16 in a forward direction to rotate the crankshaft 32 as shown in FIG. 1, the crankshaft 32 is also rotated forward with respect to the frame of the electrically assisted bicycle 10. In this case, the rotation of the crankshaft 32 is transmitted to the front sprocket 18 via the second clutch 34 and the resultant force member 42, and the rotation of the front sprocket 18 is transmitted to the rear sprocket 20 via the chain 22. When a manual drive force is inputted to the pedals 16 in a rearward direction to rotate the crankshaft 32, the crankshaft 32 is also rotated rearward with respect to the frame. In this case, the rotation of the crankshaft 32 is not transmitted to the resultant force member 42 and the front sprocket 18 by the action of the second clutch 34.

As shown in FIG. 2, the first planetary gear mechanism 36 comprises a first input body 62, a first output body 64 and a first transmission body 66.

The first input body 62 comprises a sun gear 62A that is coupled to the transmitting member 46 of the first motor 38. The sun gear 62A is provided on the outer perimeter of the transmitting member 46. The sun gear 62A is integrally rotatable with the transmitting member 46. A first one-way clutch 52 is provided between the sun gear 62A and the transmitting member 46. The first one-way clutch 52 prevents the first motor 38 from being rotated by the manual drive force being transmitted while the crankshaft 32 is rotated forward. The forward rotation of the crankshaft 32 is the rotational direction of the crankshaft 32 of while the electrically assisted bicycle 10 moves forward. The first one-way clutch 52 is, for example, a roller clutch. The first one-way clutch 52 transmits the rotation of the transmitting member 46 to the first input body 62 while the transmitting member 46 is rotated in a first direction and while the rotational speed of the first input body 62 and the rotational speed of the transmitting member 46 are equal. The first one-way clutch 52 is coupled to the transmitting member 46 and the first input body 62 so as to not transmit the rotation of the transmitting member 46 to the first input body 62 while the rotational speed of the first input body 62 is higher than the rotational speed of the transmitting member 46. The first one-way clutch 52 prevents the first motor 38 from being rotated by the manual drive force while the crankshaft 32 is rotated forward.

The first output body 64 comprises a plurality of planetary gears 64A and a carrier 64B. The planetary gears 64A are engaged with the first input body 62. The carrier 64B rotatably supports the planetary gears 64A. The first planetary gear mechanism 36 preferably comprises a plurality of the planetary gears 64A. However, the first planetary gear mechanism 36 can have only one of the planetary gears 64A.

The first transmission body 66 transmits the rotation of the first input body 62 to the first output body 64. The first transmission body 66 comprises a ring gear 66A that is engaged with the first output body 64. The ring gear 66A is disposed around the sun gear 62A so as to be coaxially disposed with the sun gear 62A. The first transmission body 66 is supported in the housing 44 via the second one-way clutch 54. The second one-way clutch 54 is, for example, a roller clutch. The second one-way clutch 54 prevents rotation of the first transmission body 66 in a prescribed direction. That is, the first transmission body 66 is rotatable in a first direction with respect to the housing 44, and is non-rotatable with respect to the housing 44 in a second direction.

The planetary gears 64A are disposed between the sun gear 62A and the ring gear 66A. The planetary gears 64A engage the sun gear 62A and the ring gear 66A. The carrier 64B rotatably supports the planetary gears 64A via a plurality of planetary pins 64C. The planetary pins 64C extend through the planetary gears 64A in the axial direction. In another example, the planetary pins 64C can be integrally rotated with the planetary gears 64A and can be rotatably supported in the carrier 64B.

The first speed reducer 48 is configured to reduce the rotational speed of the first output body 64 and transmit the rotation of the first output body 64 to the resultant force member 42. The first speed reducer 48 comprises a second planetary gear mechanism 48A. The second planetary gear mechanism 48A is provided coaxially with the first planetary gear mechanism 36. The second planetary gear mechanism 48A is disposed in a position adjacent to the first planetary gear mechanism 36 in the axial direction of the first planetary gear mechanism 36.

The second planetary gear mechanism 48A comprises a second input body 68, a second output body 70 and a second transmission body 72.

The rotation of the first output body 64 is inputted to the second input body 68. The second input body 68 comprises a sun gear 68A that is coupled to the first output body 64. The sun gear 68A is provided on the outer perimeter of the first output body 64. The sun gear 68A is integrally rotated with the first output body 64. The total number of teeth of the sun gear 68A of the second input body 68 is preferably equal to the total number of teeth of the sun gear 62A of the first input body 62.

The second output body 70 comprises a plurality of planetary gears 70A and a carrier 70B. The planetary gears 70A are engaged with the second input body 68. The carrier 70B rotatably supports the planetary gears 70A. The second planetary gear mechanism 48A preferably comprises a plurality of the planetary gears 70A. However, the second planetary gear mechanism 48A can have only one of the planetary gears 70A. The carrier 70B rotatably supports the planetary gears 70A via a plurality of planetary pins 70C. The planetary pins 70C extend through the planetary gears 70A in the axial direction. In another example, the planetary pins 70C can integrally rotate with the plurality of planetary gears 70A and can be rotatably supported in the carrier 70B.

The total number of teeth of the planetary gears 70A of the second output body 70 is preferably equal to the total number of teeth of the planetary gears 64A of the first output body 64. A gear 70D is provided to the outer perimeter part of the second output body 70. The gear 70D is provided coaxially with the second output body 70. The gear 70D is engaged with the gear 60 that is provided on the outer perimeter of the resultant force member 42. That is, the second output body 70 transmits rotation to the resultant force member 42. The gear 70D and the gear 60 constitute the speed reducer. The rotation of the second output body 70 is preferably decelerated and transmitted to the resultant force member 42. The rotation can be transmitted from the second output body 70 to the resultant force member 42 by interposing another gear between the gear 70D and the gear 60, or the rotation can be transmitted from the second output body 70 to the resultant force member 42 by an annular member. The annular member is, for example, a belt that is wound on the second output body 70 and the resultant force member 42. If the rotational direction of the second output body 70 and the rotational direction of the resultant force member 42 become the same direction, by transmitting the rotation from the second output body 70 to the resultant force member 42 by an annular member, or by interposing another gear between the gear 70D and the gear 60, the drive directions of the first motor 38 and the second motor 40 should be made the opposite the orientations of the first one-way clutch 52 and the second one-way clutch 54. The torque of the first motor 38 and the torque that is applied to the crankshaft 32 are combined in the resultant force member 42. The rotation of the first motor 38 is shifted in the first planetary gear mechanism 36 and then transmitted to the resultant force member 42. The rotation that is added to the crankshaft 32 is transmitted to the resultant force member 42 without being shifted.

The second transmission body 72 transmits the rotation of the second input body 68 to the second output body 70. The second transmission body 72 comprises a ring gear 72A that is engaged with the second output body 70. The total number of teeth of the ring gear 72A of the second transmission body 72 is preferably equal to the total number of teeth of the ring gear 66A of the first transmission body 66. The first transmission body 66 and the second transmission body 72 are integrated so as to be synchronously rotatable. Accordingly, the second transmission body 72 is rotatable in a first direction with respect to the housing 44, and is non-rotatable in a second direction with respect to the housing 44. The first transmission body 66 and the second transmission body 72 can be integrally formed, or be formed as separate bodies and integrated by coupling them together.

The first motor 38 is supported in the housing 44. The first motor 38 comprises an output shaft and a main body 38A. The main body 38A comprises a rotor and a stator (both not shown) The transmitting member 46 comprises an output shaft of the first motor 38. The transmitting member 46 transmits the rotation of the first motor 38 to the first input body 62. That is, the first motor 38 is configured to rotate the first input body 62. The first motor 38 is provided coaxially with the first planetary gear mechanism 36. The first motor 38 is disposed on the opposite side of the first speed reducer 48 across from the first planetary gear mechanism 36 with respect to the axial direction of the first planetary gear mechanism 36.

The second motor 40 is configured to rotate the first transmission body 66. The second motor 40 is supported in the housing 44. The second motor 40 comprises a main body 40A and an output shaft 40B. The main body 40A comprises a rotor and a stator (both not shown). The second motor 40 is disposed to the outside of the first motor 38 with respect to the radial direction. The rotational axis of the second motor 40 is parallel to the rotational axis of the first motor 38. A gear 40C is provided on the output shaft 40B of the second motor 40. The rotation of the second motor 40 is transmitted to the first transmission body 66 via the second speed reducer 50. The gear 40C can be coupled to the output shaft 40B via a one-way clutch in order to prevent the second motor 40 from being rotated by the manual drive force being transmitted while the crankshaft 32 is rotated forward.

The second speed reducer 50 is configured to reduce the rotational speed of the second motor 40 and transmits the rotation of the second motor 40 to the first transmission body 66. The second speed reducer 50 comprises a gear 40C provided on the output shaft 40B of the second motor 40, a support body 74 that has a gear 74A on an outer perimeter, and a gear 66B provided to the outer perimeter of the first transmission body 66. The gear 74A is provided coaxially with the support body 74 and integrally rotates with the support body 74. The support body 74 is a shaft and is rotatably supported in the housing 44. The support body 74 can be fixed to the housing 44 and can rotatably support the gear 74A. The gear 74A is engaged with the gear 40C. The gear 74A also is engaged with the gear 66B. The gear 66B is provided coaxially with the first transmission body 66. The total number of teeth of the gear 74A is greater than the total number of teeth of the gear 40C. The total number of teeth of the gear 66B is greater than the total number of teeth of the gear 74A. In the second speed reducer 50, the gear 74A can be omitted, and the gear 40C and the gear 66B can be engaged. In this case, the driving direction of the second motor 40 should be reversed. The total number of gears included in the second speed reducer 50 is not limited.

The drive unit 30 further comprises a torque sensor 76 and a rotational speed sensor (not shown). The torque sensor 76 is, for example, a strain gauge, a semiconductor strain sensor, or a magnetostrictive sensor. The torque sensor 76 is attached to the hollow shaft 58 of the resultant force member 42. The torque sensor 76 detects the torque that is applied to the resultant force member 42.

When the rotation of the crankshaft 32 is transmitted to the resultant force member 42 and the rotations of the first motor 38 and the second motor 40 are not transmitted to the resultant force member 42, the torque sensor 76 outputs a signal to the controller 56 that reflects the manual drive force that is inputted to the crankshaft 32. When the rotation of the crankshaft 32, the rotation of the first motor 38, and the rotation of the second motor 40 are transmitted to the resultant force member 42, the torque sensor 76 outputs a signal to the controller 56 that reflects the torque obtained by combining the manual drive force that is inputted to the crankshaft 32, the torque of the first motor 38, and the torque of the second motor 40 that are transmitted via the first planetary gear mechanism 36 and the first speed reducer 48.

The rotational speed sensor comprises a cadence sensor that detects the rotational speed of the crank. The cadence sensor detects, for example, a magnet that is provided on the crankshaft 32. The cadence sensor comprises a magnetism detection sensor, such as a reed switch or a hall element. The cadence sensor outputs a signal to the controller 56 corresponding to the rotational speed of the crankshaft 32. The cadence sensor can also be configured to detect a magnet that is provided on the crank arm 12. In this case, the cadence sensor outputs a signal to the controller 56 corresponding to the rotational speed of the crank arm 12. The rotational speed sensor can further comprise a speed sensor that detects the rotational speed of the front wheel or the rear wheel of the electrically assisted bicycle 10. The controller 56 calculates the rotational speed of the crank based on the detection result of the rotational speed sensor.

The controller 56 controls the first motor 38 and the second motor 40. The controller 56 controls the rotations of the first motor 38 and the second motor 40 according to the rotational speed of the crank. In one example, the controller 56 controls the outputs of the first motor 38 and the second motor 40 based on the manual drive force that is detected by the torque sensor 76, and the rotational speed of the crank and the travel speed of the electrically assisted bicycle 10 that are detected by the rotational speed sensor.

When the rotational speed of the crank becomes higher than a prescribed speed, the controller 56 controls the rotational speed of the second motor 40 so as to be higher than the rotational speed of same when the rotational speed of the crank is at the prescribed speed or lower. The controller 56 can change the rotational speed of the second motor 40 continuously, or in a stepwise manner, according to the rotational speed of the crank. The controller 56 can stop the second motor when the rotational speed of the crank is equal to or less than a prescribed speed, and rotate the second motor 40 at a set speed that is set in advance when the rotational speed of the crank becomes higher than a prescribed speed.

The relationship between the second motor 40 and the transmission ratio γX of the first planetary gear mechanism 36 will be described. The transmission ratio γX is the rotational frequency of the first output body 64 relative to the rotational frequency of the first input body 62, and becomes smaller as the rotation of the first input body 62 is decelerated.

The controller 56 rotates the first input body 62 in the first direction by rotating the first motor 38. When the first input body 62 is rotated in the first direction, a rotation in the direction in which the electrically assisted bicycle 10 moves forward is transmitted to the resultant force member 42. When the first transmission body 66 is not rotated relative to the housing 44, the rotation of the first input body 62 is decelerated and is output from the first output body 64 to the second input body 68. That is, the transmission ratio γX of the first planetary gear mechanism 36 is smaller than “1.”

The controller 56 rotates the first transmission body 66 in the first direction by rotating the second motor 40. The transmission ratio γX of the first planetary gear mechanism 36 is increased, as the rotational speed of the first transmission body 66 in the first direction is increased. When the rotational speed of the first transmission body 66 in the first direction becomes equal to the first input body 62, the transmission ratio γX of the first planetary gear mechanism 36 becomes “1.” That is, the controller 56 is configured to continuously change the transmission ratio γX by controlling the rotational speed of the second motor 40. The transmission ratio γX can be changed from a value smaller than “1” to “1” by controlling the second motor 40.

The relationship between the second motor 40 and the transmission ratio γY of the first speed reducer 48 will be described.

When the second transmission body 72 is not rotated relative to the housing 44, the rotation of the second input body 68 is decelerated and is output from the first output body 64. That is, the transmission ratio γY of the second planetary gear mechanism 48A is smaller than “1.” The transmission ratio γY is the rotational frequency of the second output body 70 relative to the rotational frequency of tie second input body 68.

The controller 56 rotates the second transmission body 72 in the first direction by rotating the second motor 40. The transmission ratio γY of the second planetary gear mechanism 48A is increased, as the rotational speed of the second transmission body 72 in the first direction is increased. When the rotational speed of the second transmission body 72 in the first direction becomes equal to the second input body 68, the transmission ratio γY of the second planetary gear mechanism 48A becomes “1.” That is, the controller 56 is configured to continuously change the transmission ratio γY by controlling the rotational speed of the second motor 40. The transmission ratio γY can be changed from a value smaller than “1” to “1” by controlling the second motor 40.

The first transmission body 66 and the second transmission body 72 are integrally rotated. Accordingly, the transmission ratio γX of the first planetary gear mechanism 36 and the transmission ratio γY of the first speed reducer 48 are correlated. The transmission ratio γY of the first speed reducer 48 is increased as the transmission ratio γX of the first planetary gear mechanism 36 is increased.

The rotation that is decelerated by the first planetary gear mechanism 36 and the first speed reducer 48 is further decelerated by the second speed reducer 50 and transmitted to the resultant force member 42. That is, the torque of the first output body 64 and the torque of the crankshaft 32 are combined in the resultant force member 42.

The action and effects of the drive unit 30 will be described.

(1) The drive unit 30 comprises a first planetary gear mechanism 36 that changes the rotational speed of the first motor 38 and transmits rotation of the first motor 38 to the resultant force member 42. It is possible to change the transmission ratio of the first planetary gear mechanism 36 by driving the second motor 40. According to this configuration, it becomes easy to suppress the rotational speed of the first motor 38 within a prescribed range; therefore, it is possible to prevent a reduction in the assisting force accompanying a change in the rotational speed of the crank.

(2) Since a second one-way clutch 54 is provided, the drive unit 30 is configured to output the rotation of the first motor 38 from the first planetary gear mechanism 36, even when power to the second motor 40 is stopped. Accordingly, it is possible to contribute to power saving.

(3) Since the first transmission body 66 and the second transmission body 72 are integrated, the drive unit 30 is configured to make the torque of the second motor 40 smaller relative to the torque of the first motor 38.

### Second Embodiment

The drive unit 30 of the second embodiment will be described, with reference to FIG. 2.

As shown in FIG. 2, the first transmission body 66 and the second transmission body 72 are individually configured as separate parts so as to be relatively rotatable.

The second one-way clutch 54 is provided between the first transmission body 66 and the housing 44. The second transmission body 72 is provided on the housing 44 such that they are relatively non-rotatable. Accordingly, the first planetary gear mechanism 36 outputs rotation that is input from the first motor 38 to the first speed reducer 48 after changing the speed according to the rotational speed of the second motor 40. The second planetary gear mechanism 48A of the first speed reducer 48 always outputs the rotation that is inputted to the second input body 68 from the second output body 70 after decelerating at a constant speed reduction ratio. In other words, the transmission ratio γX of the first planetary gear mechanism 36 is variable, and the transmission ratio γY of the second planetary gear mechanism 48A is a constant value that is smaller than “1.” According to the drive unit 30 of the second embodiment, effects corresponding to the effects of the first embodiment can be obtained.

### Modifications

The descriptions relating to each embodiment described above are examples of forms that the bicycle drive unit according to the present invention can take, and are not intended to limit the forms thereof. The bicycle drive unit according to the present invention can take the forms of the modifications of the above-described embodiments shown below, as well as forms that combine at least two modifications that are not mutually contradictory.

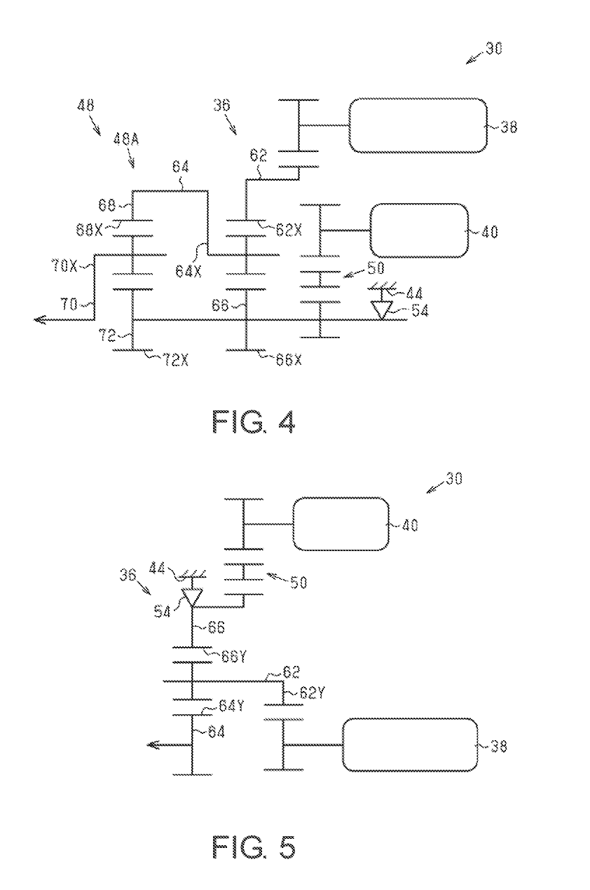

The configuration of the drive unit 30 of each embodiment can be freely changed, as shown in, for example, FIGS. 4 to 8. FIG. 4 shows a first modification of the first planetary gear mechanism 36 and the first speed reducer 48 of the drive unit 30. The first planetary gear mechanism 36 of the drive unit 30 of FIG. 4 is a configuration in which the first input body 62 comprises a ring gear 62X, the first output body 64 comprises a carrier 64X, and the first transmission body 66 comprises a sun gear 66X. By such a configuration of the first planetary gear mechanism 36, the rotation of the first motor 38 is inputted to the ring gear 62X and the rotation of the carrier 64X is output to the resultant force member 42 via the first speed reducer 48. When the sun gear 66X is not rotated, the transmission ratio γX of the first planetary gear mechanism 36 is less than “1.” The second motor 40 is connected to the transmission body 66. The first motor 38 rotates the first input body 62 in the first direction. The second motor 40 rotates the first transmission body 66 in the second direction. The transmission ratio γX is increased as the rotational speed of the first transmission body 66 in the first direction is increased.

The second planetary gear mechanism 48A of the first speed reducer 48 of FIG. 4 is preferably a configuration in which the second input body 68 comprises a ring gear 68X, the second output body 70 comprises a carrier 70X, and the second transmission body 72 comprises a sun gear 72X. The rotation of the first output body 64 is transmitted to the second input body 68. When the sun gear 72X is not rotated, the transmission ratio γY of the second planetary gear mechanism 48A is less than “1.” The transmission ratio γY is increased as the rotational speed of the second transmission body 72 in the first direction is increased. The second transmission body 72 is integrated with the first transmission body 66. The second transmission body 72 can be formed separately from the first transmission body 66 and can be fixed to the housing.

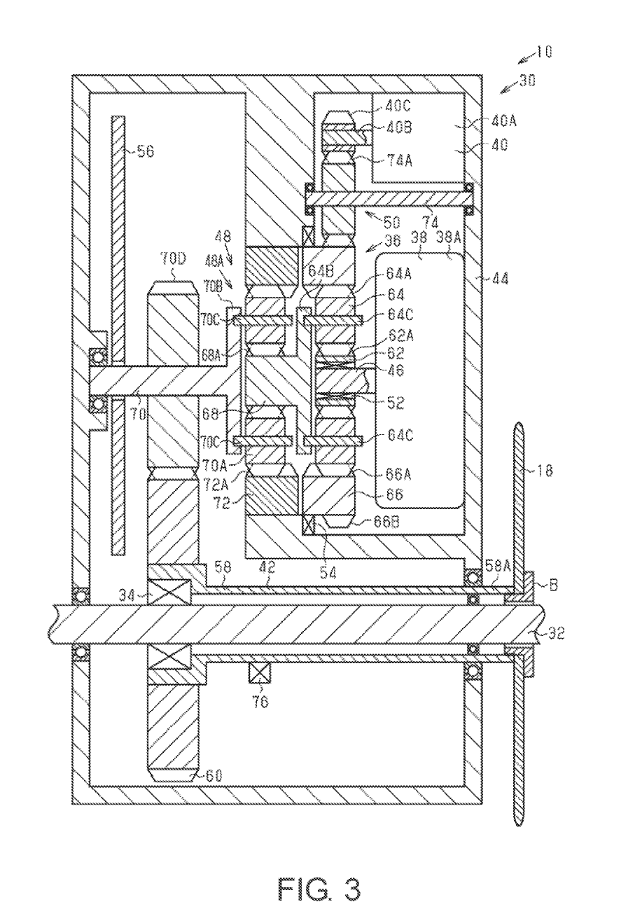

FIG. 5 shows a second modification of the first planetary gear mechanism 36 of the drive unit 30. The first planetary gear mechanism 36 of the drive unit 30 of FIG. 5 is a configuration in which the first input body 62 comprises a carrier 62Y, the first output body 64 comprises a sun gear 64Y, and the first transmission body 66 comprises a ring gear 66Y. By such a configuration of the first planetary gear mechanism 36, the rotation of the first motor 38 is inputted to the carrier 62Y and the rotation of the carrier 62Y is output to the resultant force member 42 via the first speed reducer 48. When the ring gear 66Y is not rotated, the transmission ratio γX of the first planetary gear mechanism 36 is greater than “1.” The second motor 40 is connected to the first transmission body 66. The first motor 38 rotates the first input body 62 in the first direction. The second motor 40 rotates the first transmission body 66 in the second direction. The transmission ratio γX is increased as the rotational speed of the first transmission body 66 in the second direction is increased. The second one-way clutch 54 regulates rotation of the first transmission body 66 in a first direction relative to the housing 44, and permits the rotation in a second direction. The first output body 64 can transmit the rotation to the first speed reducer 48 shown in FIG. 3 or FIG. 4, or can transmit the rotation to the gear 70D.

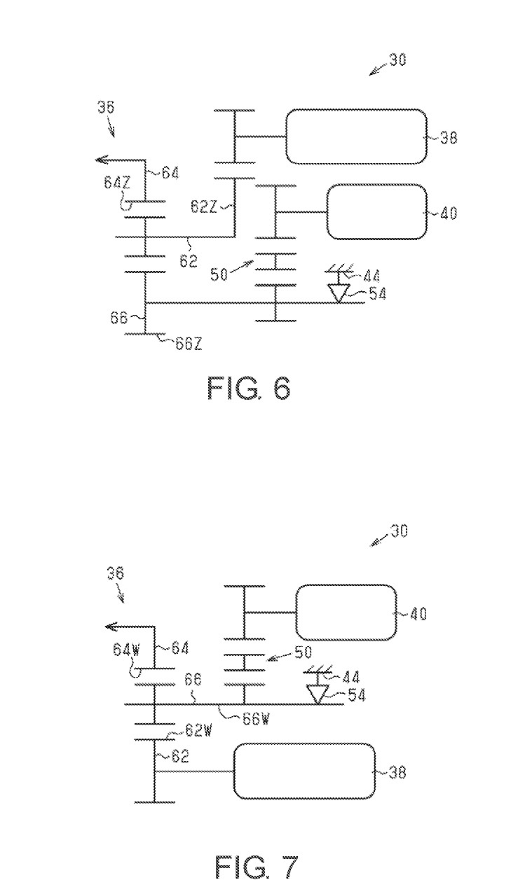

FIG. 6 shows a third modification of the first planetary gear mechanism 36 of the drive unit 30. The first planetary gear mechanism 36 of the drive unit 30 of FIG. 6 is a configuration in which the first input body 62 comprises a carrier 62Z, the first output body 64 comprises a ring gear 64Z, and the first transmission body 66 comprises a sun gear 66Z. By such a configuration of the first planetary gear mechanism 36, the rotation of the crankshaft 32 is inputted to the carrier 62Z and the rotation of the ring gear 64Z is output to the resultant force member 42 via the first speed reducer 48. When the sun gear 66Z is not rotated, the transmission ratio γX of the first planetary gear mechanism 36 is greater than “1.” The second motor 40 is connected to the first transmission body 66. The first motor 38 rotates the first input body 62 in the first direction. The second motor 40 rotates the first transmission body 66 in the second direction. The transmission ratio γX is increased as the rotational speed of the first transmission body 66 in the second direction is increased. The first output body 64 can transmit the rotation to the first speed reducer 48 shown in FIG. 3 or FIG. 4, or can transmit the rotation to the gear 70D.

FIG. 7 shows a fourth modification of the first planetary gear mechanism 36 of the drive unit 30. The first planetary gear mechanism 36 of the drive unit 30 of FIG. 7 is a configuration in which the first input body 62 comprises a sun gear 62W, the first output body 64 comprises a ring gear 64W, and the first transmission body 66 comprises a carrier 66W.

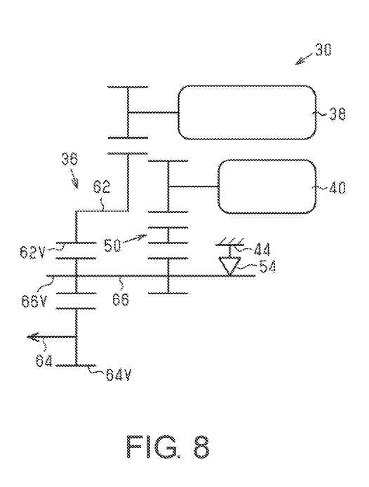

FIG. 8 shows a fifth modification of the first planetary gear mechanism 36 of the drive unit 30. The first planetary gear mechanism 36 of the drive unit 30 of FIG. 8 is a configuration in which the first input body 62 comprises a ring gear 62V, the first output body 64 comprises a sun gear 64V, and the first transmission body 66 comprises a carrier 66V. The first output body 64 of the first planetary gear mechanism 36 shown in FIGS. 7 and 8 can transmit the rotation to the first speed reducer 48 shown in FIG. 3 or FIG. 4, or can transmit the rotation to the gear 70D. Since the rotational direction of the first input body 62 in the first planetary gear mechanism 36 shown in FIGS. 7 and 8 is opposite of the rotational direction of the first output body 64, the drive directions of the first motor 38 and the second motor 40 can be reversed, or a mechanism to change the rotational direction can be provided in the power transmission path from the first output body 64 to the resultant force member 42.

In each of the embodiments, the configuration of the first speed reducer 48 can be freely changed. For example, a first speed reducer formed from a plurality of spur gears can be employed. Further, the first speed reducer 48 can be disposed on the outer side of the first planetary gear mechanism 36 in the radial direction.

The drive unit 30 in each embodiment can take a form that does not comprise the first speed reducer 48. In this case, for example, a gear that is formed on the outer perimeter of the first output body 64 and the gear 60 of the resultant force member 42 can be engaged.

The drive unit 30 in each embodiment can take a form that does not comprise the second speed reducer 50. In this case, the gear 40C of the second motor 40 is directly engaged with the gear 66B of the first transmission body 66, and the total number of teeth of the gear 40C and the total number of teeth of the gear 66B are made equal.

The drive unit 30 in each embodiment can take a form that does not comprise the first one-way clutch 52. In this case, the sun gear 62A can be formed on the outer perimeter part of the transmitting member 46. In addition, the first one-way clutch 52 can be provided between the first output body 64 and the second input body 68, be provided between the second output body 70 and the gear 70D, or be provided between the resultant force member 42 and the gear 60. The first one-way clutch 52 can be provided to any position in the drive path from the output shaft of the first motor 38 to the resultant force member 42, as long as the one-way clutch is able to prevent the first motor 38 from being rotated by the manual drive force when the crankshaft 32 is rotated forward.

The drive unit 30 of the embodiments can take a form that does not comprise the crankshaft 32. In this case, a crankshaft 32 as a component of the bicycle is provided to the drive unit 30.

The position to which the drive unit 30 is provided can be freely changed. In one example, the drive unit 30 can be provided in the vicinity of the rear sprocket 20. In this case, it is possible to configure the rear wheel hub shell as the resultant force member. The first planetary gear mechanism is coupled to the rear wheel hub shell. The first planetary gear mechanism, the first speed reduction mechanism, the first motor, and the second motor are provided inside the rear wheel hub shell. The rotation of the crankshaft 32 is transmitted to the rear wheel hub shell via the rear sprocket 20. Accordingly, the rotation of the first output body 64 is transmitted to the rear wheel hub shell, and the rotation of the crankshaft 32 is applied without interposing the first planetary gear mechanism.

In each of the embodiments, the resultant force member can be formed of the crankshaft 32. In this case, the resultant force member 42 is omitted and the rotation of the first speed reducer 48 is transmitted to the crankshaft 32.

In each of the embodiments, the second clutch 34 can be omitted.

In each of the embodiments, the first planetary gear mechanism 36 can be configured to be coupled to the end of the resultant force member 42 on the front sprocket 18 side in the axial direction of the crankshaft 32, directly, or via the first speed reducer 48, or via the first speed reducer 48 and another speed reducer. In this case, the torque sensor 76 is provided between the connecting portion of the resultant force member 42 and the crankshaft 32 and the end of the resultant force member 42 on the front sprocket side, and is configured to detect only the manual drive force, even if the motors 38 and 40 are driving. When transmitting the rotation of the first speed reducer 48 to the end of the resultant force member 42 on the front sprocket 18 side, for example, in the drive unit 30 shown in FIGS. 2 and 3, the positions of the first motor 38 and the second motor 40 should be replaced with the positions of the gear 70D and the gear 60 in the axial direction of the crankshaft 32 inside the housing 44.

In each of the embodiments, the controller 56 can be provided outside of the housing 44, or be provided to the frame of the bicycle.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

Also it will be understood that although the terms “first” and “second” may be used herein to describe various components these components should not be limited by these terms. These terms are only used to distinguish one component from another. Thus, for example, a first component discussed above could be termed a second component and vice versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example. “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle drive unit comprising:
a first planetary gear mechanism comprising a first input body, a first output body and a first transmission body that transmits rotation of the first input body to the first output body;
a first motor configured to rotate the first input body;
a second motor configured to rotate the first transmission body; and
a resultant force member configured to selectively receive rotation of the first output body and rotation by a manual drive force without interposing the first planetary gear mechanism.

2. The bicycle drive unit according to claim 1, wherein
the resultant force member is provided around a rotational axis of a crankshaft, and is rotatable around the rotational axis of the crankshaft.

3. The bicycle drive unit according to claim 1, further comprising
a transmitting member configured to transmit rotation of the first motor to the first input body.

4. The bicycle drive unit according to claim 3, wherein
the transmitting member comprises an output shaft of the first motor.

5. The bicycle drive unit according to claim 3, further comprising
a first one-way clutch configured to transmit rotation of the transmitting member to the first input body while the transmitting member is rotated in a first direction and while a rotational speed of the first input body and a rotational speed of the transmitting member are equal, and the first one-way clutch being coupled to the transmitting member and the first input body so as to not transmit the rotation of the transmitting member to the first input body while the rotational speed of the first input body is higher than the rotational speed of the transmitting member.

6. The bicycle drive unit according to claim 1, further comprising
a first speed reducer configured to reduce a rotational speed of the first output body and transmit the rotational speed of the first output body to the resultant force member.

7. The bicycle drive unit according to claim 6, wherein
the first speed reducer comprises: a second planetary gear mechanism having a second input body that receives a rotational input from the first output body, a second output body that transmits rotation to the resultant force member; and a second transmission body that transmits rotation of the second input body to the second output body.

8. The bicycle drive unit according to claim 7, wherein
the first transmission body and the second transmission body are integrated so as to be synchronously rotatable.

9. The bicycle drive unit according to claim 7, wherein
the first transmission body and the second transmission body are individually configured so as to be relatively rotatable.

10. The bicycle drive unit according to claim 7, wherein
the second input body comprises a sun gear that is coupled to the first output body;
the second output body comprises a planetary gear that is engaged with the second input body and a carrier that rotatably supports the planetary gear; and
the second transmission body comprises a ring gear that is engaged with the second output body.

11. The bicycle drive unit according to claim 1, wherein
the first input body comprises a sun gear that is coupled to the first motor;
the first output body comprises a planetary gear that is engaged with the first input body and a carrier that rotatably supports the planetary gear; and
the first transmission body comprises a ring gear that is engaged with the first output body.

12. The bicycle drive unit according to claim 1, further comprising
a second speed reducer configured to reduce a rotational speed of the second motor and transmit the rotational speed of the second motor to the first transmission body.

13. The bicycle drive unit according to claim 1, further comprising
a housing supporting the first planetary gear mechanism, the first motor and the second motor.

14. The bicycle drive unit according to claim 13, wherein
the first transmission body and the second transmission body are individually configured so as to be relatively rotatable,
the second transmission body is non-rotatable with respect to the housing.

15. The bicycle drive unit according to claim 1, further comprising
a second one-way clutch configured to prevent rotation of the first transmission body in a predetermined direction.

16. The bicycle drive unit according to claim 1, further comprising
a controller configured to control the first motor and the second motor.

17. The bicycle drive unit according to claim 16, wherein
the controller is configured to control the first motor and the second motor according to a manual drive force and a rotational speed of a crank.

18. The bicycle drive unit according to claim 17, wherein
when a rotational speed of the crank becomes higher than a prescribed speed, the controller is configured to control a rotational speed of the second motor so as to be higher than the rotational speed of the second motor when the rotational speed of the crank is the prescribed speed or lower.

19. The bicycle drive unit according to claim 17, wherein
the controller is configured to continuously change the rotational speed of the second motor in accordance with the rotational speed of the crank.

20. The bicycle drive unit according to claim 2, further comprising
a crankshaft.
